(19) United States
(12) Patent Application Publication
(10) Pub. No.: US 2012/0204552 A1
(43) Pub. Date: Aug. 16, 2012

(54) RESERVOIR TANK CONNECTION CONNECTOR, MASTER CYLINDER PROVIDED WITH THIS CONNECTOR, AND BRAKING DEVICE PROVIDED WITH THIS MASTER CYLINDER

(75) Inventor: Toshiyuki Takahashi, Saitama-ken (JP)

(73) Assignee: BOSCH CORPORATION, Tokyo (JP)

(21) Appl. No.: 13/500,436

(22) PCT Filed: Oct. 6, 2010
(86) PCT No.: PCT/JP10/05988

§ 371 Date: May 3, 2012

(30) Foreign Application Priority Data
Oct. 8, 2009 (JP) 234298/2009

(51) Int. Cl. F15B 7/00; F16L 55/00

(52) U.S. Cl. 60/533; 285/119

(57) ABSTRACT

Disclosed is a reservoir tank, comprising a connector body installed on a master cylinder, a hose connection tube body, which is arranged protruding from the edge of the connector body and has a hose connected with the reservoir tank connected thereto, and a conveying arm guide section as an interference preventing section, which is arranged on the connector body and prevents interference with the conveying jig when the connector body is supported by a conveying jig. When a conveying arm of the conveying jig abuts the conveying arm guide section and supports the connector body, the conveying arm will not interfere with the hose connection tube body due to the conveying arm guide section.

### BACKGROUND OF THE INVENTION

The present invention relates to a technical field of a reservoir tank connection connector, which is for use in a hydraulic operation device, such as a hydraulic braking device using oil pressure or other hydraulic pressure, etc., and which is for connecting a reservoir tank arranged with a space from a master cylinder and for storing a hydraulic fluid to the master cylinder via a hose, and a technical field of a master cylinder provided with the reservoir tank connection connector and for generating the hydraulic pressure, and a braking device using the master cylinder.

In the prior art, some automobiles or other vehicles adopt a hydraulic braking device as the hydraulic operation device using the hydraulic pressure. In the hydraulic braking device, a master cylinder that generates the hydraulic pressure is used, and at the same time, a reservoir tank that stores the hydraulic fluid fed to the master cylinder is also used.

For the conventional hydraulic braking device using the reservoir tank and master cylinder, the reservoir tank that is arranged with a space from the master cylinder is connected with an end of a hose [for connection] with the master cylinder, and at the same time, the other end of the hose is connected with the reservoir tank connection connector made of a resin and attached on the master cylinder. This hydraulic braking device is described in JP-A-2004-243853. In addition, JP-A-2004-243853 names the reservoir tank connection connector as a “reservoir union”.

The reservoir tank connection connector described in JP-A-2004-243853 comprises the following parts: an elongated nearly flat body with its longitudinal direction as the axial direction of the master cylinder, a L-shaped hose connection tube body, which is formed integrated with the upper surface of the body and arranged protruding significantly from the long side edge of the body on the side orthogonal to the longitudinal direction of the body, and at the same time, which is connected with the other end of the hose, and a cylinder connection tube body, which is formed integrated with the body and arranged protruding downward from the lower surface of the body, and at the same time, which is directly connected with the boss portion of the master cylinder.

However, in order to attach the reservoir tank connection connector on the master cylinder, in the prior art, the reservoir tank connection connector at the storage site is held by the conveying arm (conveying jig) of an automatic conveying robot for conveying to the site where the master cylinder is located. When the reservoir tank connection connector is conveyed by the automatic conveying robot, it is necessary to ensure that the reservoir tank connection connector is conveyed stably, and at the same time, the reservoir tank connection connector is kept in the horizontal posture and the cylinder connection tube body is kept at a good balance free of inclination with respect to the boss portion of the master cylinder. For this purpose, it is preferred that the long side edges on the two sides of the body be held and conveyed by the conveying arm of the automatic conveying robot.

However, for the reservoir tank connection connector described in JP-A-2004-243853, the L-shaped hose connection tube body protrudes significantly from the long side edge of the body. Consequently, when the long side edge of the body is held by the conveying arm of the connector conveying robot, it is believed quite possible that the conveying arm would interfere with the L-shaped hose connection tube body (that is, the conveying arm may hit the hose connection tube body). As the conveying arm interferes with the hose connection tube body, damage or dent may be generated on the hose connection tube body made of resin by the hitting force of the conveying arm, or cloudy whitening phenomenon may take place for the hose connection tube body.

Also, in JP-A-2004-243853, there is no description of the interference between the L-shaped hose connection tube body and the conveying jig when the reservoir tank connection connector is conveyed. In addition, it also did not describe even the feature of conveying of the reservoir tank connection connector by a conveying jig. That is, the reservoir tank connection connector described in JP-A-2004-243853 did not consider the problem of interference between the hose connection tube body and the conveying jig at all.

### SUMMARY OF THE INVENTION

The purpose of the present invention is to solve the problems of the prior art by providing a reservoir tank connection connector that can prevent interference between the hose connection section and the conveying jig, a master cylinder provided with the reservoir tank connection connector, and a braking device using the master cylinder.

In order to realize the purpose, the present invention provides a reservoir tank connection connector, including at least the following parts: a connector body installed on a master cylinder, a hose connection section, which is arranged protruding from the edge of the connector body and which has a hose connected with the reservoir tank connected to it, and an interference preventing section, which is arranged on the connector body and which prevents interference with the conveying jig when the connector body is supported by a conveying jig.

In addition, the reservoir tank connection connector of the present invention has the following characteristic features: the connector body is formed in a rectangular shape or nearly rectangular shape; the hose connection section is arranged extending from the upper portion of the connector body and protruding outwardly from the long side edge on one side of the connector body; and the interference preventing section is arranged along the long side edge on one side, and it is the conveying arm guide section that guides the conveying arm of the conveying jig.

In addition, the reservoir tank connection connector of the present invention has the following characteristic features: the conveying arm guide section is arranged along the long side edge on one side of the connector body where the hose connection section protrudes, and it has a first conveying arm guide section that guides the first conveying arm of the conveying jig; at the same time, it has a second conveying arm guide section which is arranged along the long side edge of other side of the connector body in which the hose connection is arranged not to protrude and that guides the second conveying arm of the conveying jig; the first conveying arm has a first supporting surface formed by a slope surface, and at the same time, the second conveying arm has a second supporting surface formed by a slope surface; the slope surfaces of the first and second supporting surfaces together form a nearly V shape; the first conveying arm guide section has a first supported surface inclined to contact the first supporting surface, and at the same time, the second conveying arm guide section has a second supported surface inclined to contact the second supporting surface; and the slope surfaces of the first and second supported surfaces together form a nearly V shape.

In addition, the reservoir tank connection connector of the present invention has the following characteristic feature: the first conveying arm guide section is arranged protruding from the upper portion of the connector body, and it is arranged divided along the long side edge on one side other than the region where the hose connection section protrudes.

In addition, the present invention also provides a master cylinder characterized by the following facts: the master cylinder at least comprises of the following parts: a cylinder body, a piston, which can be inserted into the cylinder body in liquid-tight state and in a slidable way to form a hydraulic chamber and which can generate hydraulic pressure in the hydraulic chamber when working, a hydraulic fluid supply hole, which is arranged on the cylinder body and is normally connected with the hydraulic chamber, and a reservoir tank connection connector, which is installed on the hydraulic fluid supply hole and which supplies the hydraulic fluid in the reservoir tank to the hydraulic fluid supply hole; and the reservoir tank connection connector is any one type of the types of the reservoir tank connection connector of the present invention described above.

Also, the present invention provides a braking device characterized by the following facts: the braking device at least comprises the following parts: a reservoir tank that stores the hydraulic fluid, a master cylinder, which has a reservoir tank connection connector connected with the reservoir tank via a hose, and which supplies the hydraulic fluid in the reservoir tank via the hose and the reservoir tank connection connector, and at the same time, generates a braking pressure in working, and a braking cylinder that works under the hydraulic pressure from the master cylinder; and the master cylinder here is the master cylinder of the present invention.

For the reservoir tank connection connector of the present invention with the constitution, the reservoir tank connection connector has an interference preventing section that prevents interference of the conveying jig with the hose connection section protruding from the edge of the connector body. Consequently, when the reservoir tank connection connector is conveyed, the interference preventing section can reliably prevent the conveying jig from hitting the hose connection section. As a result, it is possible to prevent generation of damage or dent on the hose connection section due to the hitting force of the conveying jig, and at the same time, it is possible to improve the sealing property between the hose connection section and the hose. Especially, when the connector body and hose connection section are formed monolithically from a resin to form the reservoir tank connection connector, it is possible to prevent cloudy whitening phenomenon of the hose connection section due to the hitting force of the conveying jig.

Also, the upper portion of the connector body is formed in a rectangular or nearly rectangular shape, and at the same time, a pair of conveying arm guide sections is arranged along the long side edges on the two sides corresponding to them, respectively, to guide the pair of conveying arms of the conveying jig. Consequently, the supported surfaces of the conveying arm guide sections of the two long side edges are supported by the supporting surfaces of the two conveying arms, so that the reservoir tank connection connector can be conveyed with a high stability.

Furthermore, the conveying arms include a first conveying arm and a second conveying arm as a pair, and the conveying arm guide sections include a first conveying arm guide section and a second conveying arm guide section as a pair guiding the corresponding first and second conveying arms, respectively. The first and second conveying arms each have a first and a second supporting surfaces that together form a nearly V shape, and at the same time, the first and second conveying arm guide sections each have a first and a second supported surfaces that together form a nearly V shape. Here, the first and second supporting surfaces support and are in contact with the corresponding first and second supported surfaces, respectively. Consequently, while the first and second supporting surfaces contact with and support the first and second supported surfaces, respectively, it is possible to hold the reservoir tank connection connector horizontally as it is centered with respect to the center of the conveying jig.

In addition, the hose connection section is arranged extending from the upper portion of the connector body and protruding outwardly from the long side edge on one side of the connector body. Also, the first and second conveying arm guide sections are arranged protruding from the upper portion of the connector body, and they are arranged divided along the long side edge on one side outside the region where the hose connection section protrudes. That is, the first conveying arm guide section protruding upward is not arranged on the long side edge of the region where the hose connection section protrudes. Consequently, it is possible to lower the hose connection section to approach the long side edge. As a result, even when the first conveying arm guide section protruding upward is arranged on the long side edge of the connector body, it is still possible to suppress the height of the hose connection section. At the same time, even when the height of the hose connection section is decreased, it is still possible to prevent interference between the first conveying arm and the hose connection section by the first conveying arm guide section. As a result, it is possible to realize a reservoir tank connection connector that can decrease the height of the hose connection section while preventing interference between the first conveying arm and the hose connection section.

In addition, as the position of the hose connection section connected with the hose connected with the reservoir tank is decreased, it is possible to further lower the connection position of the hose. As a result, the layout of the hose becomes easier, and it is possible to improve the capability in handling and bending the hose.

Besides, as the conveying arm guide section is divided and arranged except the long side edge of the region where the hose connection section protrudes, it is possible to extend the hose connection section.

In addition, by arranging the conveying arm guide section protruding upward, it is possible to reduce the thickness of the plate-shaped upper portion of the connector body of the reservoir tank connection connector. As a result, it is possible to prevent deformation, such as bending, etc., due to contraction when resin is molded for the reservoir tank connection connector. Especially, as the peripheral wall protrudes downward on the peripheral edge of the upper portion of the connector body, and the connector body is formed in a cuboid shape, it is possible to efficiently prevent deformation caused by contraction in resin molding.

In addition, as the conveying arm guide section is divided as it is arranged, it is easy to set the position of the hose stopper that positions the tip of the hose fit on the hose connection section while being arranged on the connector body or the hose connection section.

According to the master cylinder provided with the reservoir tank connection connector of the present invention, it is possible to suppress the height of the reservoir tank connection connector. Consequently, it is possible to form the master cylinder in a small size and compact shape while the reservoir tank connection connector is installed. As a result, it is possible to prevent interference with the other parts in the engine room with a limited space for configuration. Consequently, it is possible to improve the degree of freedom in configuration of the master cylinder.

On the other hand, for the braking device provided with the master cylinder of the present invention, it is possible to improve the degree of freedom for arranging the master cylinder, so that it is possible to improve the degree of freedom in handling and bending the braking hydraulic pipeline.

### BRIEF DESCRIPTION OF THE DRAWINGS

FIG. 1 is a schematic diagram illustrating the hydraulic braking device in an example of the embodiment of the reservoir tank connection connector of the present invention.

FIG. 2 illustrates the master cylinder having the reservoir tank connection connector installed on it. (a) is a front view, (b) is a plane view, and (c) is a left side view.

FIG. 3 is a cross-sectional view taken across III-III in FIG. 2(b).

FIG. 4 illustrates the reservoir tank connection connector. (a) is a front view, (b) is a plane view, (c) is a left side view, (d) is a cross-sectional view taken across IVD-IVD in (b), and (e) is a cross-sectional view taken across IVE-IVE in (b).

FIG. 5 illustrates the effect in preventing interference between the conveying arm and the hose connection tube body. (a) is a diagram illustrating the state when the conveying arm is inserted, and (b) is a diagram illustrating the state when the reservoir tank connection connector is raised by the conveying arm.

FIG. 6 illustrates the conveying jig. (a) is a front view, (b) is a plane view, (c) is a right side view, (d) is an enlarged view of portion VID in (c), and (e) is an enlarged view of portion IVE.

### DETAILED DESCRIPTION

In the following, the optimum embodiment of the present invention will be explained with reference to the drawings.

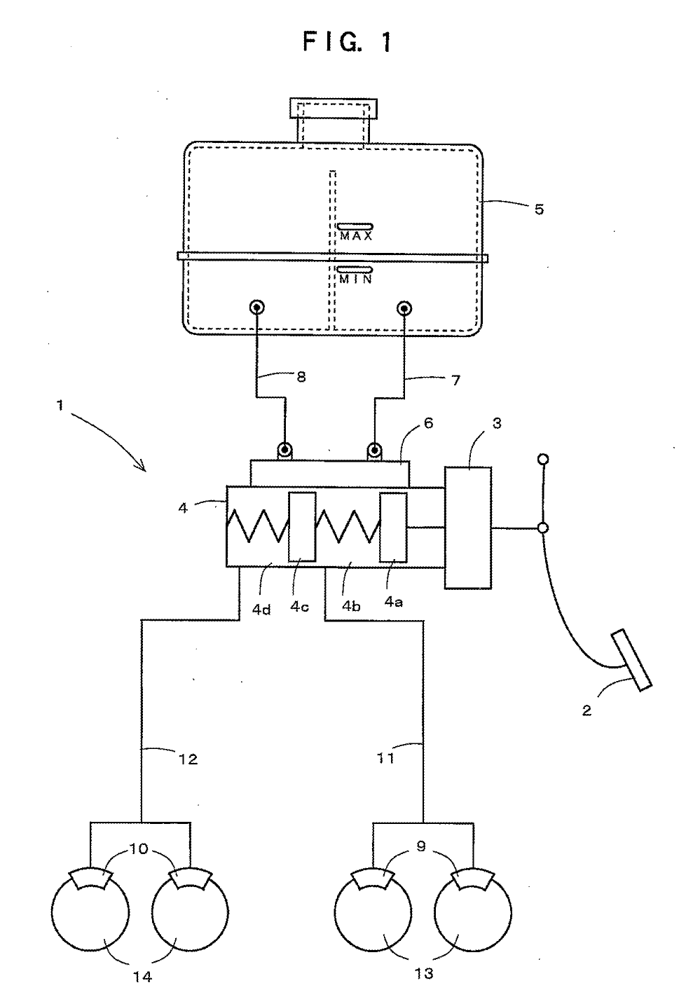

FIG. 1 is a schematic diagram illustrating the braking device provided with an example of the embodiment of the reservoir tank connection connector of the present invention.

As shown in 1, in this example, hydraulic braking device 1 is basically the same as the well known dual hydraulic braking device in the prior art. That is, hydraulic braking device 1 comprises the following parts: brake pedal 2, booster 3, tandem master cylinder 4, reservoir tank 5, reservoir tank connection connector 6, hoses 7, 8 as dual brake fluid supply pipelines, dual braking cylinders 9, 10, and dual braking hydraulic pipelines 11, 12.

While reservoir tank 5 is arranged with a space from tandem master cylinder 4, reservoir tank connection connector 6 is installed on tandem master cylinder 4. Here, reservoir tank 5 and reservoir tank connection connector 6 are connected with each other via hoses 7, 8. Then, the brake fluid as the hydraulic fluid in reservoir tank 5 is supplied via dual hoses 7, 8 and reservoir tank connection connector 6 to primary hydraulic chamber 4b and secondary hydraulic chamber 4d of tandem master cylinder 4, respectively. The brake fluid supplied to tandem master cylinder 4 is then further fed via dual braking hydraulic pipelines 11, 12 to braking cylinders 9, 10 of the systems, respectively.

When the driver steps down brake pedal 2, booster 3 works to boost and output the force stepping on the pedal with a prescribed servo ratio. The output of booster 3 drives primary piston 4a of the cylinder body of tandem master cylinder 4, so that the brake fluid of primary hydraulic chamber 4b is fed via braking hydraulic pipeline 11 to brake cylinder 9 of one system. Also, secondary piston 4c is driven, so that the brake fluid in secondary hydraulic chamber 4d is fed via braking hydraulic pipeline 12 to brake cylinder 10 of the other system. As the loss strokes in the brake systems diminish, tandem master cylinder 4 generates a hydraulic pressure. The hydraulic pressure generated by tandem master cylinder 4 is transmitted to braking cylinders 9, 10, respectively, so that braking cylinders 9, 10 generate a brake force, and brake is applied to wheels 13, 14 of the systems.

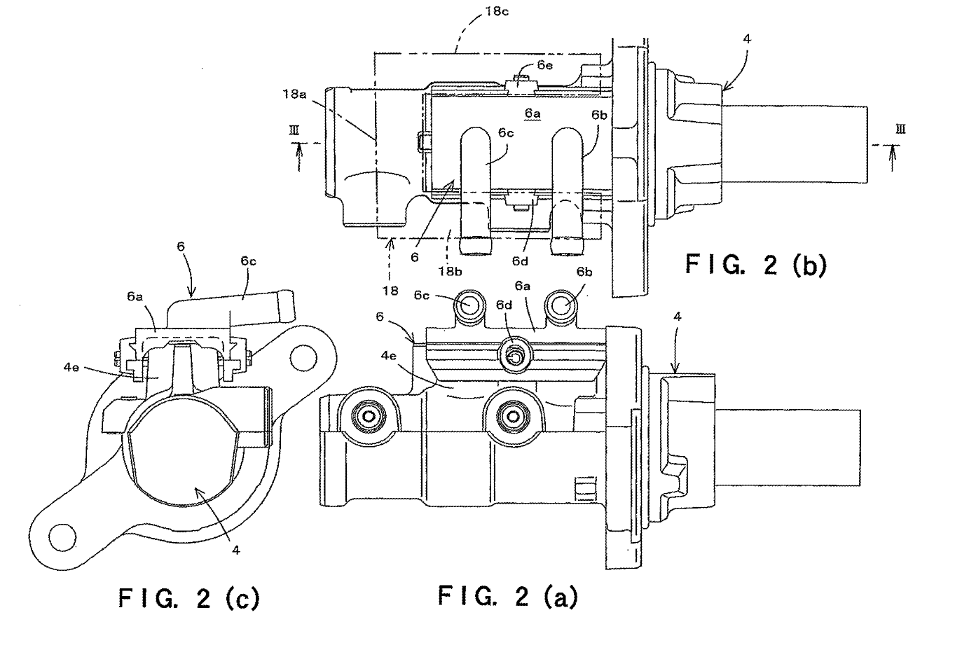

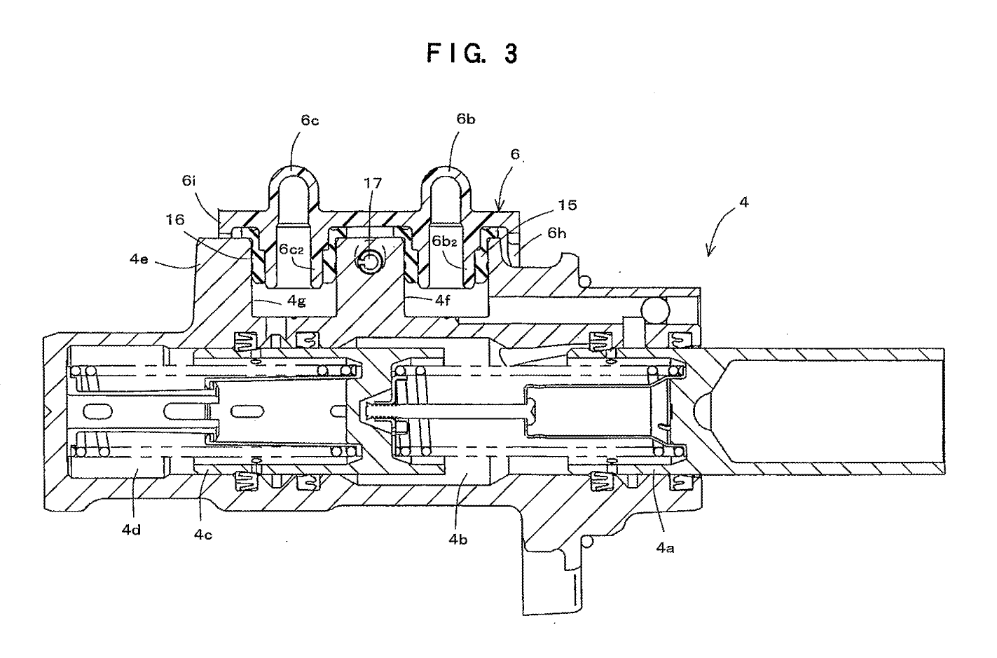

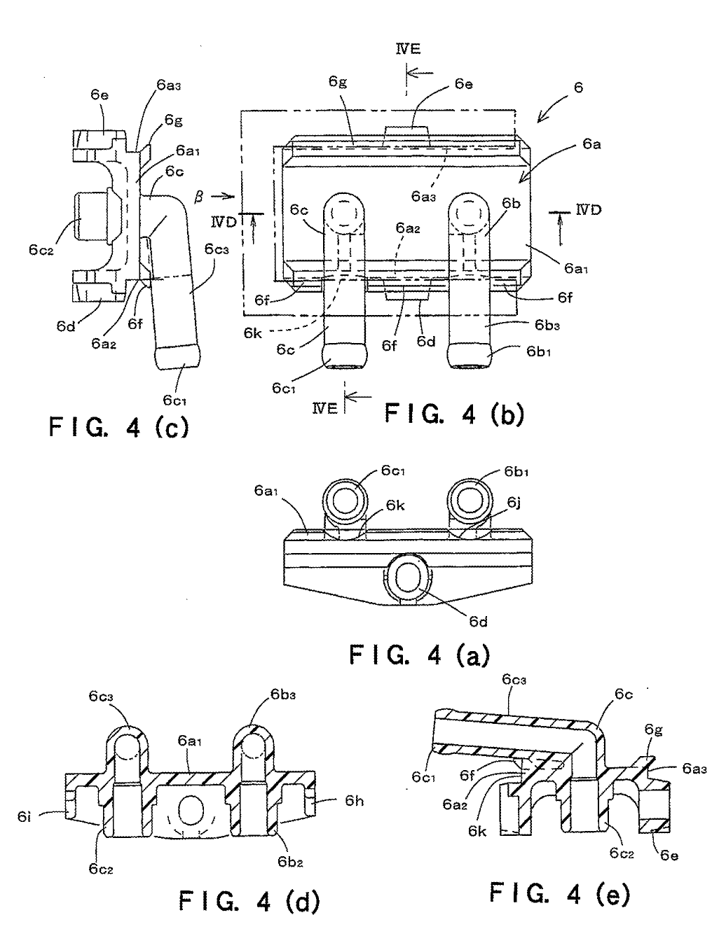

As shown in FIGS. 2(a) through (c) and FIG. 3, reservoir tank connection connector 6 in this example is installed above tandem master cylinder 4. As shown in FIGS. 4(a) through (c), reservoir tank connection connector 6 comprises the following parts: connector body 6a in a rectangular shape or nearly rectangular shape, a pair of hose connection tube bodies 6b, 6c made of L-shaped pipes anchored with a prescribed spacing between them in plate-shaped upper portion 6a1 of connector body 6a and through this upper portion 6a1, a pair of mounting boss sections 6d, 6e, and a pair of conveying arm guide sections 6f, 6g arranged extending on the long side edge of upper portion 6a1 of connector body 6a. The nearly rectangular shape of connector body 6a means that any shape is alright as long as a pair of long side edges are in straight linear shape, while the short side edges may not necessarily be of a straight linear shape. They may be arc shape or other curved shape as well.

The L-shaped pair of hose connection tube bodies 6b, 6c each have two nipple-shaped hose connection sections 6b1, 6c1 protruding significantly from one long side edge 6a2 of connector body 6a, and master cylinder side connection sections 6b2, 6c2 arranged in brake fluid supply holes 4f, 4g of brake fluid supply boss section 4e of tandem master cylinder 4 shown in FIG. 3. Here, hose connection sections 6b1, 6c1 each have one end connected with the other end of hoses 7, 8, which each have one end connected with reservoir tank 5. In addition, as shown in FIG. 3, master cylinder side connection sections 6b2, 6c2 are liquid-tightly fit in brake fluid supply holes 4f, 4g of tandem master cylinder 4 via sealing members 15, 16, respectively, and at the same time, reservoir tank connection connector 6 is supported on brake fluid supply boss section 4e. Here, brake fluid supply holes 4f, 4g are connected with primary hydraulic chamber 4b and secondary hydraulic chamber 4d, respectively, when tandem master cylinder 4 is not working

Mounting boss sections 6d, 6e as a pair are installed coaxially, and at the same time, they are connected with brake fluid supply boss section 4e by connecting pins 17. In addition, as shown in FIG. 4(d), on the short side edges on the two sides of upper portion 6a1 of connector body 6a, supporting sections 6h, 6i are erected downward respectively. These supporting sections 6h, 6i can make contact with brake fluid supply boss section 4e of tandem master cylinder 4.

Conveying arm guide sections 6f, 6g each have the cross-section in the direction orthogonal to the longitudinal direction formed in a nearly parallelogram shape. In this case, while one conveying arm guide section 6f is arranged on long side edge 6a2 on one side where hose connection sections 6b1, 6c1 of hose connection tube bodies 6b, 6c as a pair protrude, the other conveying arm guide section 6g is arranged on long side edge 6a3 on the other side facing one long side edge 6a2. In addition, conveying arm guide section 6f on one side is not arranged on regions (portions) 6j, 6k of long side edge 6a2 where hose connection sections 6b1, 6c1 protrude. Instead, it is arranged as it is divided intermittently along long side edge 6a2. On the other hand, the other conveying arm guide section 6g is arranged continuously along long side edge 6a3 over the entirety of long side edge 6a3.

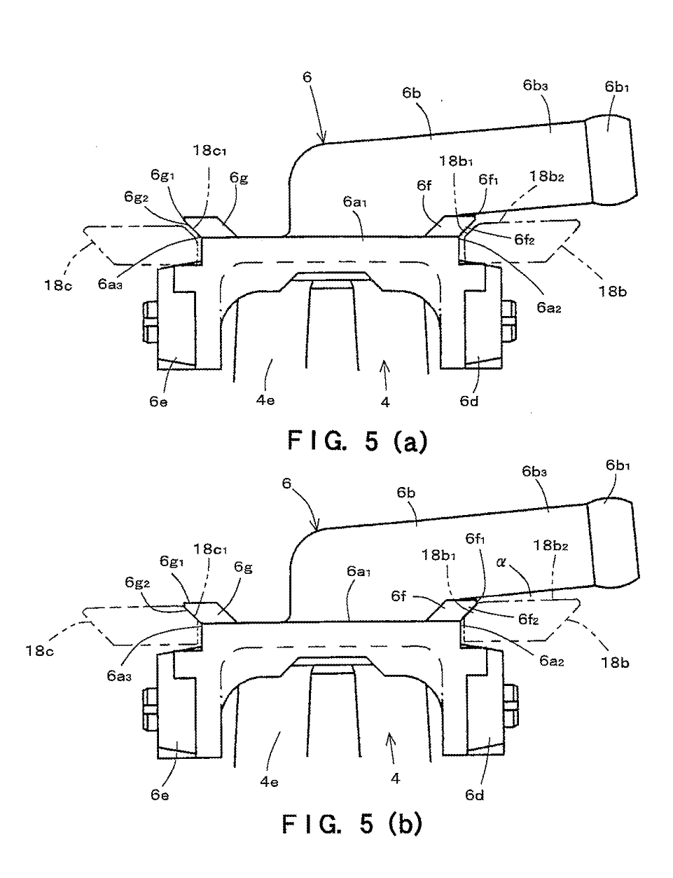

As shown in FIGS. 5(a) and (b), conveying arm guide sections 6f, 6g are formed protruding upward from the upper surface of upper portion 6a1 of connector body 6a. Here, while one conveying arm guide section 6f is arranged protruding outward (to the right hand side shown in FIG. 5(a)) from long side edge 6a2 on one side, there is a supported surface 6f2 from the plate shaped slope surface between its protruding end 6f1 and long side edge 6a2. On the other hand, the other conveying arm guide sections 6g are formed protruding outward (to the left hand side shown in FIG. 5(a)) from the other long side edge 6a3, while there is a supported surface 6g2 made of the plate shaped slope surface between its protruding end 6g1 and long side edge 6a3. Conveying arm guide sections 6f, 6g are arranged symmetrically while their cross-sectional shapes are formed in the same size.

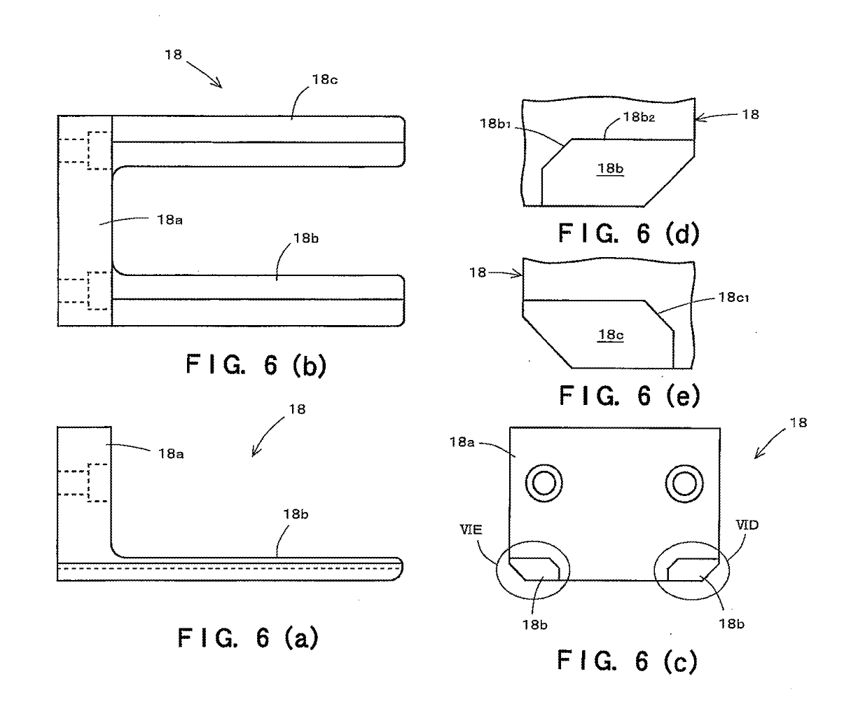

As shown in FIGS. 6(a) through (c), conveying jig 18 for conveying reservoir tank connection connector 6 comprises attachment section 18a attached on the automatic conveying robot not shown in the drawing, and a pair of slender conveying arms 18b, 18c arranged extending parallel with each other. Slender conveying arms 18b, 18c as a pair are formed protruding from the two end surfaces of attachment section 18a with a prescribed spacing between them, and conveying jig 18 has a front view in an L shape (and it has a plane view in U shape).

Conveying arms 18b, 18c each have a hexagonal cross-sectional shape in the longitudinal direction. As shown in FIG. 6(d), one conveying arm 18b has supporting surface 18b1 made of a slope surface on its inner-side upper end. The inclination angle of supporting surface 18b1 with respect to the horizontal direction is selected to be equal to or nearly equal to the inclination angle of supported surface 6f2 of conveying arm guide section 6f with respect to the horizontal direction. Also, as shown in FIG. 6(e), the other conveying arm 18c has supporting surface 18c1 made of a slope surface on its inner-side upper end. The inclination angle of supporting surface 18c1 with respect to the horizontal direction is selected to be equal to or nearly equal to the inclination angle of supported surface 6g2 of conveying arm guide section 6g with respect to the horizontal direction. Here, conveying arms 18b, 18c are formed with their cross-sections in the same size, and at the same time, they are formed symmetric to each other. Consequently, two supporting surfaces 18b1, 18c1 have their slope surfaces together depicting a nearly V shape, and so do the two supported surfaces 6f2, 6g2.

Then, as conveying jig 18 conveys reservoir tank connection connector 6, conveying arms 18b, 18c indicated by double-dot-dash lines in FIG. 5(a) can enter the portion below supported surface 6f2 of conveying arm guide section 6f and supported surface 6g2 of conveying arm guide section 6g, respectively. In addition, supporting surfaces 18b1, 18c1 of conveying arms 18b, 18c can make contact with supported surfaces 6f2, 6g2 of conveying arm guide sections 6f, 6g, respectively.

As indicated by the double-dot-dash lines in FIG. 5(b), while one supporting surface 18b1 is in contact with supported surface 6f2, a prescribed gap is generated between upper surface 18b2 of one conveying arm 18b and the lower surface of hose sealing section 6b3 of hose seal connecting part 6b2 protruding from long side edge 6a2, so that conveying arm 18b does not interfere (that is, do not hit) with hose connection tube body 6b on one side. Also, although not shown in FIGS. 5(a) and (b), when supporting surface 18b1 is in contact with supported surface 6f2, similarly, prescribed gap is also generated between upper surface 18b2 of conveying arm 18b and the lower surface of hose sealing section 6c3 of the other hose connection tube body 6c, so that conveying arm 18b does not interfere with the other hose connection tube body 6c. That is, while one conveying arm guide section 6f works as the supported section of conveying arm 18b, it also works as an interference preventing section for preventing interference between conveying arm 18b and hose connection tube bodies 6b, 6c.

As explained above, two supporting surfaces 18b1, 18c1 are slope surfaces that together form a V shape, and so are the two supported surfaces 6f2, 6g2. Consequently, while two supporting surfaces 18b1, 18c1 are in contact with their corresponding supported surfaces 6f2, 6g2, respectively, reservoir tank connection connector 6 is held horizontally as it is centered at the center in the direction orthogonal to the longitudinal direction of conveying jig 18 (that is, the vertical direction shown in FIG. 6(b)).

For reservoir tank connection connector 6 in this example with the constitution, it is conveyed from the storage site of reservoir tank connection connector 6 to the site where it is assembled to tandem master cylinder 4. In this case, as shown in FIG. 4(b), conveying arms 18b, 18c of conveying jig 18 of the automatic conveying robot are driven to move in the β direction from the front side in the longitudinal direction of reservoir tank connection connector 6, and, as shown in FIG. 5(a), they are inserted to below supported surface 6f2 of conveying arm guide section 6f and supported surface 6g2 of conveying arm guide section 6g, respectively. As these conveying arms 18b, 18c are being driven to carry out insertion, a prescribed gap (play) is generated between supporting surfaces 18b1, 18c1 of conveying arms 18b, 18c and supported surfaces 6f2, 6g2 of conveying arm guide sections 6f, 6g, respectively. Consequently, conveying arm 18b on one side does not interfere with hose connection tube bodies 6b, 6c.

Next, conveying jig 18 is raised, and supporting surfaces 18b1, 18c1 of conveying arms 18b, 18c make surface contact or nearly surface contact with supported surfaces 6f2, 6g2 of conveying arm guide sections 6f, 6g, respectively. In this case, one conveying arm guide section 6f stops the relative rising movement of conveying arm 18b with respect to reservoir tank connection connector 6. As a result, even when the one conveying arm 18b rises, as prescribed gap is generated between supporting surfaces 18b1, 18c1 and supported surfaces 6f2, 6g2, no interference takes place with hose connection tube bodies 6b, 6c. In addition, as conveying jig 18 is raised, two conveying arms 18b, 18c raise reservoir tank connection connector 6 from the site of storage. In this case, as supported surfaces 6f2, 6g2 of reservoir tank connection connector 6 and supporting surfaces 18b1, 18c1 of conveying arms 18b, 18c are inclined together to depict a V shape, reservoir tank connection connector 6 is raised horizontally or nearly horizontally as it is centered at the center in the direction orthogonal to the longitudinal direction of conveying jig 18.

Then, as shown in FIG. 2(b), the automatic conveying robot conveys reservoir tank connection connector 6 to the site for assembling it to tandem master cylinder 4. Here, even during conveying of reservoir tank connection connector 6 by the automatic conveying robot, while reservoir tank connection connector 6 is conveyed with high stability, it is conveyed with good balance in the horizontal posture without inclination of master cylinder side connection sections 6b2, 6c2 with respect to brake fluid supply holes 4f, 4g of boss section 4e of master cylinder 4, respectively.

For reservoir tank connection connector 6 in this example, there is conveying arm guide section 6f as an interference preventing section for preventing interference between conveying arm 18b of conveying jig 18 and hose connection tube bodies 6b, 6c. Consequently, when reservoir tank connection connector 6 is conveyed, by conveying arm guide section 6f, it is possible to reliably prevent contact of conveying arm 18b with hose sealing sections 6b3, 6c3 of hose connection tube bodies 6b, 6c. As a result, it is possible to prevent generation of damage or dent on hose connection tube bodies 6b, 6c made of resin by the hitting force of conveying arm 18b, and at the same time, it is possible to prevent generation of cloudy whitening phenomenon of hose connection tube bodies 6b, 6c.

In addition, while upper portion 6a1 of connector body 6a is formed in a rectangular shape or nearly rectangular shape, conveying arm guide sections 6f, 6g as a pair are arranged along long side edges 6a2, 6a3 on the two sides corresponding to them, respectively, so that conveying arms 18b, 18c as a pair of conveying jig 18 are guided. Consequently, as supporting surfaces 18b1, 18c1 of conveying arms 18b, 18c support supported surfaces 6f2, 6g2 of conveying arm guide sections 6f, 6g on the two long side edges 6a2, 6a3, reservoir tank connection connector 4 can be conveyed with high stability.

In addition, hose connection tube bodies 6b, 6c are arranged extending from upper section 6a1 of connector body 6, and they protrude outward from long side edge 6a2 on one side of connector body 6. In this case, conveying arm guide section 6f on the side where hose connection tube bodies 6b, 6c protrude outward is arranged divided and protruding upward only on long side edge 6a2 excluding regions 6j, 6k including the site where hose connection tube bodies 6b, 6c protrude. Consequently, on long side edge 6a2 of regions 6j, 6k where hose connection tube bodies 6b, 6c protrude, conveying arm guide section 6f protruding upward is not arranged. Consequently, by lowering hose sealing sections 6b3, 6c3, it is possible to approach long side edge 6a2. As a result, even when conveying arm guide section 6f protruding upward is arranged on long side edge 6a2 of connector body 6a, it is still possible to suppress the height of hose connection tube bodies 6b, 6c, and at the same time, even when the height of hose connection tube bodies 6b, 6c is lowered, it is still possible to prevent interference between conveying arm 18b and hose sealing sections 6b3, 6c3 by supported surface 6f2 of conveying arm guide section 6f. In this way, it is possible to realize reservoir tank connection connector 6 that can prevent interference between conveying arm 18b and hose sealing sections 6b3, 6c3 while lowering the height of hose connection tube bodies 6b, 6c.

In addition, as the positions of hose sealing sections 6b3, 6c3 are decreased, it is possible to further lower the connecting positions of hoses 7, 8. As a result, the layout of hoses 7, 8 becomes easier, and the capability in handling and bending hoses 7, 8 can be improved.

In addition, as conveying arm guide section 6f is arranged divided excluding long side edge 6a2 of regions 6j, 6k where hose connection tube bodies 6b, 6c protrude, it is possible to expand hose sealing sections 6b3, 6c3 of hose connection tube bodies 6b, 6c.

In addition, as conveying arm guide sections 6f, 6g are arranged protruding upward, plate shaped upper portion 6a1 of connector body 6a of reservoir tank connection connector 6 can be made thinner. As a result, the bending deformation or the like can hardly take place during a contraction when the resin is molded to form reservoir tank connection connector 6. Especially, when the peripheral wall is formed protruding downward on the peripheral edge of upper portion 6a1, and connector body 6a is formed in a cuboid shape, it is possible to efficiently prevent deformation caused by contraction when the resin is molded to form it.

In addition, as conveying arm guide section 6f is arranged divided, it is easy to set the position for the hose stopper (not shown in the drawing) that positions the tips of hoses 7, 8 arranged on connector body 6a or hose connection tube bodies 6b, 6c and fit with hose sealing sections 6b3, 6c3.

In addition, as explained above, the two supporting surfaces 18b1, 18c1 and the two supported surfaces 6f2, 6g2 are both formed as slope surfaces, so that while supporting surfaces 18b1, 18c1 are in contact with their corresponding supported surfaces 6f2, 6g2, reservoir tank connection connector 6 can be held horizontally while centered with respect to the center of conveying jig 18 as explained above.

In addition, for tandem master cylinder 4 provided with reservoir tank connection connector 6, it is possible to suppress the height of reservoir tank connection connector 6. Consequently, it is possible to form tandem master cylinder 4 with reservoir tank connection connector 6 installed on it in a small size and compact shape. As a result, it is possible to prevent interference between tandem master cylinder 4 and other parts in the engine room that has a limited space for configuration. Consequently, it is possible to increase the degree of freedom in configuration of tandem master cylinder 4.

On the other hand, for hydraulic braking device 1 provided with tandem master cylinder 4 in this example, it is possible to increase the degree of freedom for configuration of tandem master cylinder 4, so that it is possible to increase the degree of freedom for handling and bending dual braking hydraulic pipelines 11, 12.

The reservoir tank connection connector of the present invention can be adopted preferably as the reservoir tank connection connector for connecting a reservoir tank for storing the hydraulic fluid with a master cylinder.

Also, the master cylinder provided with the reservoir tank connection connector of the present invention can be preferably adopted as the master cylinder for generating hydraulic pressure in a hydraulic operation device, such as a hydraulic braking device, etc., using the oil pressure or other hydraulic pressure.

In addition, the braking device of the present invention can be preferably used in the hydraulic braking device using a master cylinder.

1. A reservoir tank connection connector, comprising at least the following parts:
a connector body installed on a master cylinder,
a hose connection section, which is arranged protruding from an edge of the connector body and has a hose connected with a reservoir tank connected thereto, and
an interference preventing section, which is arranged on the connector body and prevents interference with a conveying jig when the connector body is supported by the conveying jig.

2. The reservoir tank connection connector according to claim 1, wherein the connector body is formed in a rectangular shape or nearly rectangular shape;
the hose connection section is arranged extending from an upper portion of the connector body and protruding outwardly from a long side edge on one side of the connector body; and
the interference preventing section is arranged along the long side edge on one side, and a conveying arm guide section guides a conveying arm of the conveying jig.

3. The reservoir tank connection connector according to claim 2, wherein the conveying arm guide section is arranged along the long side edge on one side of the connector body where the hose connection section protrudes, and has a first conveying arm guide section that guides a first conveying arm of the conveying jig; and at the same time, has a second conveying arm guide section that guides a second conveying arm of the conveying jig, provided along a long edge of the other side of the connector body in which the hose connection section does not protrude; the first conveying arm has a first supporting surface formed by a slope surface, and at the same time, the second conveying arm has a second supporting surface formed by a slope surface; the slope surfaces of the first and second supporting surfaces together form a nearly V shape; the first conveying arm guide section has a first supported surface inclined to contact the first supporting surface, and at the same time, the second conveying arm guide section has a second supported surface inclined to contact the second supporting surface; and the slope surfaces of the first and second supported surfaces together form a nearly V shape.

4. The reservoir tank connection connector according to claim 3, wherein the first and second conveying arm guide sections are arranged protruding from the upper portion of the connector body, and arranged divided along the long side edge on one side other than the region where the hose connection section protrudes.

5. A master cylinder comprising
a cylinder body,
a piston that can be inserted into the cylinder body in a liquid-tight state and in a slidable way to form a hydraulic chamber and can generate a hydraulic pressure in the hydraulic chamber when working,
a hydraulic fluid supply hole, which is arranged on the cylinder body and is normally connected with the hydraulic chamber, and
a reservoir tank connection connector, which is installed on the hydraulic fluid supply hole and which supplies the hydraulic fluid in a reservoir tank to the hydraulic fluid supply hole;
wherein the reservoir tank connection connector is the reservoir tank connection connector according to claim 1.

6. A braking device, having at least the following parts:
a reservoir tank that stores hydraulic fluid,
a master cylinder, which has a reservoir tank connection connector connected to the reservoir tank via a hose, and supplies the hydraulic fluid in the reservoir tank via the hose and the reservoir tank connection connector, and at the same time, generates a braking pressure in working, and
a braking cylinder that works under the hydraulic pressure from the master cylinder;
wherein the master cylinder is the master cylinder according to claim 5.

7. The master cylinder according to claim 5, wherein the connector body is formed in a rectangular shape or nearly rectangular shape;
the hose connection section is arranged extending from an upper portion of the connector body and protruding outwardly from a long side edge on one side of the connector body; and
the interference preventing section is arranged along the long side edge on one side, and a conveying arm guide section guides a conveying arm of the conveying jig.

8. The master cylinder according to claim 7, wherein the conveying arm guide section is arranged along the long side edge on one side of the connector body where the hose connection section protrudes, and has a first conveying arm guide section that guides a first conveying arm of the conveying jig; and at the same time, has a second conveying arm guide section that guides a second conveying arm of the conveying jig, provided along a long edge of the other side of the connector body in which the hose connection section does not protrude; the first conveying arm has a first supporting surface formed by a slope surface, and at the same time, the second conveying arm has a second supporting surface formed by a slope surface; the slope surfaces of the first and second supporting surfaces together form a nearly V shape; the first conveying arm guide section has a first supported surface inclined to contact the first supporting surface, and at the same time, the second conveying arm guide section has a second supported surface inclined to contact the second supporting surface; and the slope surfaces of the first and second supported surfaces together form a nearly V shape.

9. The master cylinder according to claim 8, wherein the first and second conveying arm guide sections are arranged protruding from the upper portion of the connector body, and arranged divided along the long side edge on one side other than the region where the hose connection section protrudes.

10. The braking device according to claim 6, wherein the connector body is formed in a rectangular shape or nearly rectangular shape;
the hose connection section is arranged extending from an upper portion of the connector body and protruding outwardly from a long side edge on one side of the connector body; and
the interference preventing section is arranged along the long side edge on one side, and a conveying arm guide section guides a conveying arm of the conveying jig.

11. The braking device according to claim 10, wherein the conveying arm guide section is arranged along the long side edge on one side of the connector body where the hose connection section protrudes, and has a first conveying arm guide section that guides a first conveying arm of the conveying jig; and at the same time, has a second conveying arm guide section that guides a second conveying arm of the conveying jig, provided along a long edge of the other side of the connector body in which the hose connection section does not protrude; the first conveying arm has a first supporting surface formed by a slope surface, and at the same time, the second conveying arm has a second supporting surface formed by a slope surface; the slope surfaces of the first and second supporting surfaces together form a nearly V shape; the first conveying arm guide section has a first supported surface inclined to contact the first supporting surface, and at the same time, the second conveying arm guide section has a second supported surface inclined to contact the second supporting surface; and the slope surfaces of the first and second supported surfaces together form a nearly V shape.

12. The braking device according to claim 11, wherein the first and second conveying arm guide sections are arranged protruding from the upper portion of the connector body, and arranged divided along the long side edge on one side other than the region where the hose connection section protrudes.
